(19) United States
(12) Patent Application Publication
(10) Pub. No.: US 2017/0047703 A1
(43) Pub. Date: Feb. 16, 2017

(54) HOMOGENEOUS PUMP STRUCTURE OF LASER, AND DESIGN METHOD FOR STRUCTURE

(71) Applicant: HAN'S LASER TECHNOLOGY INDUSTRY GROUP CO., LTD., Shenzhen, Guangdong (CN)

(72) Inventors: Sumei HUANG, Shenzhen (CN); Kesheng CHEN, Shenzhen (CN); Yunfeng GAO, Shenzhen (CN)

(73) Assignee: HAN'S LASER TECHNOLOGY INDUSTRY GROUP CO., LTD., Shenzhen, Guangdong (CN)

(21) Appl. No.: 15/303,479

(22) PCT Filed: May 14, 2014
(86) PCT No.: PCT/CN2014/077481

§ 371 Date: Oct. 11, 2016

(51) Int. Cl. H01S 3/067; H01S 3/094

(52) U.S. Cl. CPC H01S 3/06733; H01S 3/06745; H01S 3/094003; H01S 3/06729; H01S 3/094019; H01S 3/094042

(57) ABSTRACT

A homogeneous pump structure of laser, and a design method for the homogeneous pump structure of laser. The homogeneous pump structure of laser is used in a fiber laser or a fiber laser amplifier, and comprises a gain fiber (21). The gain fiber (21) comprises a pump light input end and a pump light output end. The pump area of the gain fiber (21) gradually decreases from the pump light input end to the pump light output end, so that a change rate between a pump light absorption capacity of each of segments, with equal lengths, of the gain fiber (21) and a pump light absorption capacity of a neighboring segment is smaller than b %, b being an empirical value.

### FIELD OF THE INVENTION

The present disclosure relates to an optical field, and more particularly relates to a homogeneous pump structure of a laser, and further relates to a method for designing a homogeneous pump structure of a laser.

### BACKGROUND OF THE INVENTION

The fiber laser and the fiber laser amplifier have characteristics such as a compact structure, a high conversion efficiency, a better light beam quality, easy for heat dissipation and easy to realize a high power, and are extensively applied to various application fields such as industrially process, communication, medical treatment, scientific research, and military affairs. The double clad fiber (DCOF, double clad optical fiber) structure permits a pump light with a low brightness and a high power to be coupled into a cladding of an optical fiber, and enable a signal light thereof to be effectively amplified in a small fiber core, and a laser with a higher light beam quality can be obtained. The double clad fiber combining with a high power pumping source, a continuous wave (CW) fiber laser has reached a kilowatt and a number of kilowatts magnitudes. Although the fiber laser has a greater surface-to-volume ratio, however, in the operation of a high power laser, the heat effect is an important issue to be considered, which directly influences an enhancement and a further development of a power output of the fiber laser.

The conventional pump methods are listed as below:

1. End Pump

The ended pump method is an earliest pump method adopted by a double clad fiber, and is also a pump method which is easy to be achieved. The pump light is directly focused on the fiber end by passing through a lens coupling system, a dichroic mirror closely contact the fiber end to serve as an ante-chamber lens of the laser. The technology requires performing a meticulous design to the coupling system, when designing, parameters such as an output aperture of the pump light, the size of the light spot, the shape, the size and the numerical aperture of the inner cladding of the doping optical fiber, to enable the pump light can be effectively coupled into the inner cladding of the double clad fiber. The dichroic mirror is required to have a high transmittance for the pump light and a high reflection for the lasing laser. The output end can directly outputs by taking advantage of the fiber end, and can also output by virtue of a dichroic mirror having a specific reflectivity. Because the high power pump light is directly focused on the fiber end closely contacting the dichroic mirror, the coating of the dichroic mirror is required to have a high damage threshold value.

In order to obtain a high power output, two pumping sources may be adopted to perform a bidirectional pump to the optical fiber. By adopting the end pump, a high power output can be obtained, and the laser can be easily constituted. However, it has some inherent disadvantages: because the dichroic mirror is employed to serve as an endoscope, a precise adjusting advice is required, and a requirement for the working environment of the laser is extremely high. The structure of the laser is not compact enough. It is inputted and outputted by the end surface, thus an annular cavity is difficult to be constituted and so on. Further, in such technology, because a completely matching between a size of the focusing spot, a numerical aperture, a size of the end surface of the inner cladding of the optical fiber, and an acceptance angle is difficult to be realized, a coupling efficient is generally not high.

2. V-Groove Coupling Pump Technology

In order to overcome a constraint of the fiber end by the end pump method, a V-groove pump technology is invented. The V-groove pump technology takes advantage of a characteristic of a greater size of the inner cladding of the double clad fiber, after the coating and the outer cladding of a segment of the double clad fiber being stripped, a V shaped groove is defined on one side surface of the inner cladding. The pump light is focused by a micro-lens and is then perpendicularly injected into the inner cladding of the double clad fiber from an opposite side. The pump light is focused by a lens from a side to transmit into a bevel edge of the V-groove, and is totally reflected into the fiber core by the bevel edge and is propagating. The bevel angle of the V-groove is determined according to parameters of the optical fiber and the pump light, the pump which is reflected into the fiber core is required to satisfy the total reflection conditions of propagating in the inner cladding. Taking advantage of the technology, the end surface of the fiber is free, such that an annular chamber structure can be formed easily, the signal light can also be easily injected when the amplifier is manufactured. Further, a position of the pump can be determined freely, a bidirectional pump and a multipoint array type pump can be easily realized, and a high power is obtained. Compared to the end pump method, a loss of the coating which is caused by focusing the pump light on the endoscope is inexistence. However, engraving the V-groove on the inner cladding requires an extreme high level micro-etch technology, it is difficult to process, and in addition, the V-groove pump structure is also complex.

3. Tapered Fiber Coupling Pump Technology

In aforementioned two technologies, it requires additional devices such as a collimating lens to focus the pump light to the inner cladding of the optical fiber, the system is complex. The tapered fiber coupling pump technology (also known as optical fiber combiner) is an improved end pump coupling method, such method requires no coupling lens, and merely adopts the tapered fiber to compress the large-method-area diameter light spot outputted by the tail fiber into the double clad fiber having a relative smaller cross-segment, a particular fiber bragg grating is adopted as a laser endoscope. The method eliminates an additional loss brought by the lens module, a coupling efficiency is greater than a conventional end pump coupling method, and the whole system is integrated into one body, the structure is compact and stable. There are no exact demands for the working environment of the laser which facilitates to a large-scale application of the laser. However, an annular laser cavity structure and a laser amplifier cannot be realized, and is not suitable for a plurality of high power laser pumping source to pump simultaneously.

In order to obtain a higher power output, researchers further develop the technology, and a tapered fiber bundle coupling technology, i.e. the optical fiber bundle constituted by a plurality of optical fibers is contracted into a single multimode optical fiber which matches with a size of the double clad fiber, and then is connected to the double clad fiber. Each fiber on a front end can be connected to one pumping source, such technology can be adopted to obtain an extreme high power output. After being designed, an optical fiber in the centre of the optical fiber bundle can serve as an input signal light, which facilitates to manufacture the optical fiber laser amplifier and constitute the annular cavity laser. However, the tapered fiber coupling technology requires a higher level processing technology, and the simultaneous welding technology of the fiber core and the inner cladding of the double clad fiber is quite difficult. In addition, when a plurality of high power lasers is inputted simultaneously, it needs to pay special attention to the heat damage of the coupler.

4. Side Pumping Method

The structure of the side pumping method includes one gain fiber and one pump fiber. The introduced pump light in the pump fiber can enter the gain fiber through contact surfaces of the two optical fibers, and is absorbed by the gain fiber to generate a signal light.

In above introductive fiber laser, the light absorptive rate of every segment of the optical fiber are the same, the pump light power at the pump input end is the greatest, therefore, the input end is the position where absorbs the pump power most, and where the temperature is the highest. When it runs under a high power, it is very common that a temperature difference between the lowest temperature and the highest temperature reaches one hundred, which greatly limits an increase of an optical power.

### SUMMARY

Accordingly, it is necessary to provide a homogeneous pump structure of laser which can enhance a power output of a fiber laser.

A homogeneous pump structure of a laser used in a fiber laser or a fiber laser amplifier includes: a gain fiber having a pump light input end and a pump light output end, wherein a pump area of the gain fiber gradually decreases from the pump light input end to the pump light output end, such that a change rate of a pump light absorption capacity between each segment with an equal length and an adjacent segment of the gain fiber is less than b %, wherein b is an empirical value.

According to an embodiment, the homogeneous pump structure adopts a tapered fiber coupling pump method, the gain fiber includes a fiber core and an inner cladding which is contact with and closely surrounds the fiber core, when a cross section area of the gain fiber is equivalent to a circular, a ratio of a diameter of the fiber core to a diameter of the inner cladding gradually increases from the pump light input end to the pump light output end.

According to an embodiment, the homogeneous pump structure adopts an end pumped method, the gain fiber has a fiber core and an inner cladding which is contact with and closely surrounds the fiber core, when a cross section area of the gain fiber is equivalent to a circular, a ratio of a diameter of the fiber core to a diameter of the inner cladding increases gradually.

According to an embodiment, a deviation between a diameter of an actual fiber core and a diameter of a theoretical designed fiber core falls within ±c %, a deviation between a diameter of an actual inner cladding and a diameter of a theoretical designed inner cladding falls within ±c %, c is an empirical value, the diameter of the theoretical designed fiber core and the diameter of the theoretical designed inner cladding satisfy the following conditions:

P*{1−10̂[a(ds₁²/dp₁²)*L/n]}=P*{10̂[−a(ds₁²/dp₁²)*L/n]}*{1−10̂[−a(ds₂²/dp₂²)*L/n]}= . . . = P*{10̂[−a(ds₁²/dp₁² + . . . + dsₙ₋₁²/dpₙ₋₁²)*L/n]}*{1−10̂[−a(dsₙ²/dpₙ²)*L/n]}

wherein P represents an initial power of the pump light inputted into the gain fiber, L represents a total length of the gain fiber, n represents that the gain fiber is divided into n segments with equal lengths, dsᵢ represents the theoretical designed diameter of each segment of the fiber core, dpᵢ represents the theoretical designed diameter of each segment the inner cladding, a represents that an adsorption of the pump light by the fiber core is a decibels per meter.

According to an embodiment, the theoretical designed diameter ds of the fiber core remains invariable, the theoretical designed diameter of the inner cladding gradually decreases from the pump light input end.

According to an embodiment, the theoretical designed diameter dp of the inner cladding remains invariable, the theoretical designed diameter of the fiber core gradually increases from the pump light input end.

According to an embodiment, dsᵢ/dpᵢ of each segment of the gain fiber is changed according to an equal proportion.

According to an embodiment, the homogeneous pump structure is a unidirectional pump structure having a single-end-pumped input.

According to an embodiment, the homogeneous pump structure is a bidirectional pump structure having a two-end-pumped input, wherein a number of the gain fibers is two, the two gain fibers are connected to each other and mirror symmetric about a position where they are connected.

According to an embodiment, the homogeneous pump structure adopts a side pump method, and the homogeneous pump structure includes a pump fiber and a gain fiber contacting each other, when a cross section area of the gain fiber is equivalent to a circular, a ratio of a diameter of an the pump light absorption segment of the gain fiber to a diameter of the pump fiber gradually increases from the pump light input end to the pump light output end.

According to an embodiment, a deviation between a diameter of an actual pump fiber and a diameter of a theoretical designed pump fiber falls within ±c %, a deviation between a diameter of an actual gain fiber and a diameter of a theoretical designed gain fiber falls within ±c %, c is an empirical value, the diameter of the theoretical designed pump fiber and the diameter of the theoretical designed gain fiber satisfy the following conditions:

$$P * [ 1 - 10 \hat{} ( - a * \frac{{ds}_{1}^{2}}{{dp}_{1}^{2} + {ds}_{1}^{2}} * L / n ) ] = P * [ 10 \hat{} ( - a * \frac{{ds}_{1}^{2}}{{dp}_{1}^{2} + {ds}_{1}^{2}} * L / n ) ] * [ 1 - 10 \hat{} ( - a * \frac{{ds}_{2}^{2}}{{dp}_{2}^{2} + {ds}_{2}^{2}} * L / n ) ] = … = P * \{ 10 \hat{} [ - a * ( \frac{{ds}_{1}^{2}}{{dp}_{1}^{2} + {ds}_{1}^{2}} + … + \frac{{ds}_{n - 1}^{2}}{{dp}_{n - 1}^{2} + {ds}_{n - 1}^{2}} ) * L / n ] \} * \{ 1 - 10 \hat{} [ - a * \frac{{ds}_{n}^{2}}{{dp}_{n}^{2} + {ds}_{n}^{2}} * L / n ] \}$$

wherein P represents an initial power of the pump light inputted into the pump fiber, L represents a total length of the pump light absorption segment of the gain fiber, n represents that the pump light absorption segment is divided into n segments with equal lengths, dsᵢ represents the theoretical designed diameter of one segment of the pump light absorption segment, dpᵢ represents the theoretical designed diameter of one segment the pump fiber, a represents that an adsorption of the pump light by the gain fiber is a decibels per meter

According to an embodiment, the theoretical designed diameter ds of the pump light absorption segment of the gain fiber remains invariable, the theoretical designed diameter of the pump fiber gradually decreases from the pump light input side.

According to an embodiment, the theoretical designed diameter dp of the pump fiber remains invariable, the theoretical designed diameter of the pump light absorption segment of the gain fiber gradually increases from the pump light input side.

According to an embodiment, the homogeneous pump structure is a unidirectional pump structure having a single-end-pumped input.

According to an embodiment, the homogeneous pump structure is a bidirectional pump structure having a double-end-pumped input, wherein a number of the gain fibers is two, a number of the pump fibers is two, the two gain fibers are connected to each other and mirror symmetric about a position where they are connected, the two pump fibers are connected to each other and mirror symmetric about a position where they are connected.

A method for designing a homogeneous pump structure of a laser used in a fiber laser and a fiber laser amplifier, the structure includes a gain fiber having a pump light input end and a pump light output end, the method includes:

making a cross section area of the gain fiber equivalent to a circular;

giving a total length L to the gain fiber, giving a decibels per meter to an adsorption of the pump light by the fiber core of the gain fiber, dividing the gain fiber into n segments with equal lengths;

designing an appropriate diameter of a theoretical designed fiber core and an appropriate diameter of a theoretical designed inner cladding to satisfy the following formula:

P*{1−10̂[−a(ds₁²/dp₁²)*L/n]}P*{10̂[−a(ds₁²/dp₁²)*L/n]}*{1−10̂[−a(ds₂²/dp₂²)*L/n]}= . . . = P*{10̂[−a(ds₁²/dp₁² + . . . +dsₙ₋₁²/dpₙ₋₁²)*L/n]}*{1−10̂[−a(dsₙ²/dpₙ²)*L/n]}

wherein P represents an initial power of the pump light inputted into the gain fiber, dsᵢ represents the theoretical designed diameter of one segment of the fiber core, dpᵢ represents the theoretical designed diameter of one segment of the inner cladding.

According to an embodiment, the homogeneous pump structure adopts a tapered fiber coupling pump method.

According to an embodiment, the homogeneous pump structure of a laser adopts an end pumped method.

According to an embodiment, the theoretical designed diameter ds of the fiber core of the gain fiber remains invariable, the theoretical designed diameter of the inner cladding gradually decreases from the pump light input end.

According to an embodiment, the theoretical designed diameter dp of the inner cladding of the gain fiber remains invariable, the theoretical designed diameter of the fiber core gradually increases from the pump light input end.

According to an embodiment, dsᵢ/dpᵢ of each segment of the gain fiber is changed according to an equal proportion.

According to an embodiment, the homogeneous pump structure of a laser is a unidirectional pump structure having a single-end-pumped input.

According to an embodiment, the homogeneous pump structure of a laser is a bidirectional pump structure having a two-end-pumped input, wherein a number of the gain fibers is two, the two gain fiber are connected to each other and mirror symmetric about a position where they are connected.

According to an embodiment, further includes: manufacturing a gain fiber according to a diameter of a theoretical designed fiber core and a diameter of a theoretical designed inner cladding which are obtained by calculation, wherein a deviation between a diameter of an actual fiber core of the manufactured gain fiber and a diameter of a theoretical designed fiber core falls within ±c %, a deviation between a diameter of an actual inner cladding of the manufactured gain fiber and a diameter of a theoretical designed inner cladding falls within ±c %.

A method for designing a homogeneous pump structure of a laser used in a fiber laser and a fiber laser amplifier, the structure adopts a side pumped method and includes a pump fiber and a gain fiber, the method includes:

making cross sections of the pump fiber and the gain fiber equivalent to circulars;

giving a total length L to the pump light absorption segment of the gain fiber, giving a decibels per meter to an adsorption of the pump light by the gain fiber, dividing the pump light absorption segment into n segments with equal lengths;

designing an appropriate diameter of a theoretical designed pump fiber and an appropriate diameter of a theoretical designed gain fiber to satisfy the following formula:

$$P * [ 1 - 10 \hat{} ( - a * \frac{{ds}_{1}^{2}}{{dp}_{1}^{2} + {ds}_{1}^{2}} * L / n ) ] = P * [ 10 \hat{} ( - a * \frac{{ds}_{1}^{2}}{{dp}_{1}^{2} + {ds}_{1}^{2}} * L / n ) ] * [ 1 - 10 \hat{} ( - a * \frac{{ds}_{2}^{2}}{{dp}_{2}^{2} + {ds}_{2}^{2}} * L / n ) ] = … = P * \{ 10 \hat{} [ - a * ( \frac{{ds}_{1}^{2}}{{dp}_{1}^{2} + {ds}_{1}^{2}} + … + \frac{{ds}_{n - 1}^{2}}{{dp}_{n - 1}^{2} + {ds}_{n - 1}^{2}} ) * L / n ] \} * \{ 1 - 10 \hat{} [ - a * \frac{{ds}_{n}^{2}}{{dp}_{n}^{2} + {ds}_{n}^{2}} * L / n ] \}$$

wherein P represents an initial power of the pump light inputted into the pump fiber, dsᵢ represents the theoretical designed diameter of one segment of the pump light absorption segment, dpᵢ represents the theoretical designed diameter of one segment of the pump fiber.

According to an embodiment, the theoretical designed diameter ds of the pump light absorption segment of the gain fiber remains invariable, the theoretical designed diameter of the pump fiber gradually decreases from the pump light input side.

According to an embodiment, the theoretical designed diameter dp of the pump fiber remains invariable, the theoretical designed diameter of the pump light absorption segment of the gain fiber gradually increases from the pump light input side.

According to an embodiment, the homogeneous pump structure of a laser is a unidirectional pump structure having a single-end-pumped input.

According to an embodiment, the homogeneous pump structure of a laser is a bidirectional pump structure having a two-end-pumped input, a number of the gain fibers is two, a number of the pump fibers is two, the two gain fibers are connected to each other and mirror symmetric about a position where they are connected, the two pump fibers are connected to each other and mirror symmetric about a position where they are connected.

According to an embodiment, further includes: manufacturing a pump fiber and a gain fiber according to a diameter of a theoretical designed pump fiber and a diameter of a theoretical designed gain fiber which are obtained by calculation, wherein a deviation between an actual diameter of a manufactured pump fiber and a diameter of a theoretical designed pump fiber falls within ±c %, a deviation between an actual diameter of a manufactured gain fiber and a diameter of a theoretical designed gain fiber falls within ±c %.

In aforementioned homogeneous pump structure of a laser, a change of the actual absorption pump light of each segment of the gain fiber is little, the heating is mainly determined by a quantum defect between the excited laser and the pump light. Because the quantum defect is constant, thus the heating change is also little. Therefore, a situation that the conventional fiber laser and the fiber laser amplifier have a low homogeneity can be changed, the heat can be uniformly distributed along the whole gain fiber, a homogeneous heat dissipation of the fiber laser can be ensured, a heat damage resistant capability of the gain fiber can be greatly enhanced, thereby an actual power output of the fiber laser is greatly improved.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1a is a perspective view of a gain fiber of a fiber laser of a tapered fiber coupling pump method in a unidirectional pump according to an embodiment;

FIG. 1b is a cross-segmental view, taken along line A-A of FIG. 1a;

FIG. 2a is a perspective view of a gain fiber of a fiber laser of a tapered fiber coupling pump method in a bidirectional pump according to an embodiment;

FIG. 2b is a cross-segmental view, taken along line A-A of FIG. 2a;

FIG. 3a is a perspective view of a gain fiber and a pump fiber of a fiber laser of a side pumping method in a unidirectional pump according to an embodiment;

FIG. 3b is a cross-segmental view, taken along line B-B of FIG. 3a;

FIG. 4a is a perspective view of a gain fiber and a pump fiber of a fiber laser of a side pumping method in a bidirectional pump according to an embodiment; and

FIG. 4b is a cross-segmental view, taken along line B-B of FIG. 2a.

### DETAILED DESCRIPTION OF THE EMBODIMENTS

The above and other objects, features and advantages of the present invention will become more apparent by describing in detail with reference to the accompanying drawings.

The heat damage of the double clad fiber coating is one of the dominant factors limiting the operation of a high power continuous fiber laser and a fiber laser amplifier, which greatly limits a maximum power output and a stability of the laser system. The low refractive polymer coating of the conventional double clad fiber itself is sensitive to temperature. When the temperature reaches 150° C. to 200° C., a heat damage tends to be aroused, a stable operation for a long time requires a temperature lower than 80° C. The invention takes advantage of a variation of the pump area along an axial direction of the optical fiber to modify an absorptive rate of each segment of the gain fiber for the pump light. Specifically, a pump area of the gain fiber gradually decreases from the pump light input end to the pump light output end, causing a pump light absorbing capacity of each segment of the gain fiber with equal lengths remains almost invariable. In consideration of a restriction of a manufacturing technology and influences of other aspects, a change rate of a pump light absorption capacity between each segment with an equal length and an adjacent segment of the gain fiber is less than b %, wherein b is an empirical value.

For the fiber laser of the embodiment that adopts the tapered fiber coupling pump method, an initial power of the pump light inputted into the gain fiber is defined as P, a total length of the gain fiber is L, the gain fiber is divided into n segments with equal lengths, the diameter of one segment of the fiber core is dsᵢ (i ∈[1, n] and i is a natural number), a diameter of the inner cladding is dpᵢ, the adsorption of the pump light by the fiber core is a decibels per meter. It should be noted that the diameter of the inner cladding mentioned in the specification and the claims indicates a diameter that includes a diameter of the fiber core. In order to satisfy a condition of which a pump area of the gain fiber gradually decreases from the pump light input end to the pump light output end, a ratio of the diameter dsᵢ of the fiber core to the diameter dpᵢ of the inner cladding is required to be gradually increased. It is illustrated with reference to one embodiment in the following:

For the first segment of the gain fiber starting from the pump light input end, i.e. the first segment of the gain fiber which connects the tapered fiber coupler, the power of absorbing the pump light is: P*{1−10̂[−a(ds₁²/dp₁²)*L/n]};

For the second segment of the gain fiber, the power of absorbing the pump light is: P*{10̂[−a(ds₁²/dp₁²)L/n]}*{1−10̂[−a(ds₂²/dp₂²)*L/n]};

Similarly, for the nth segment of the gain fiber, the power of absorbing the pump light is:

P*{10̂[−a(ds₁²/dp₁² + . . . +dsₙ₋₁²/dpₙ₋₁²)*L/n]}*{1−10̂[−a(dsₙ²/dpₙ²)*L/n]}

The L, a and n are given, various required combinations which enables the pump light absorption power of each segment of the gain fiber to be equal can be solved by virtue of mathematical calculation software tools such as Matlab, and Maple. In practical production, the cross section of the manufactured optical fiber may not be circular, and rather, it has shapes such as octagon, D shaped, and hexagon. One skilled in the art can make the manufactured gain fiber equivalent to a circular cross section according to a requirement, after that, on basis of above theoretical calculation, an adjustment within ±c % is performed to the diameter of the actual fiber core and the diameter of the actual inner cladding, c is an empirical value.

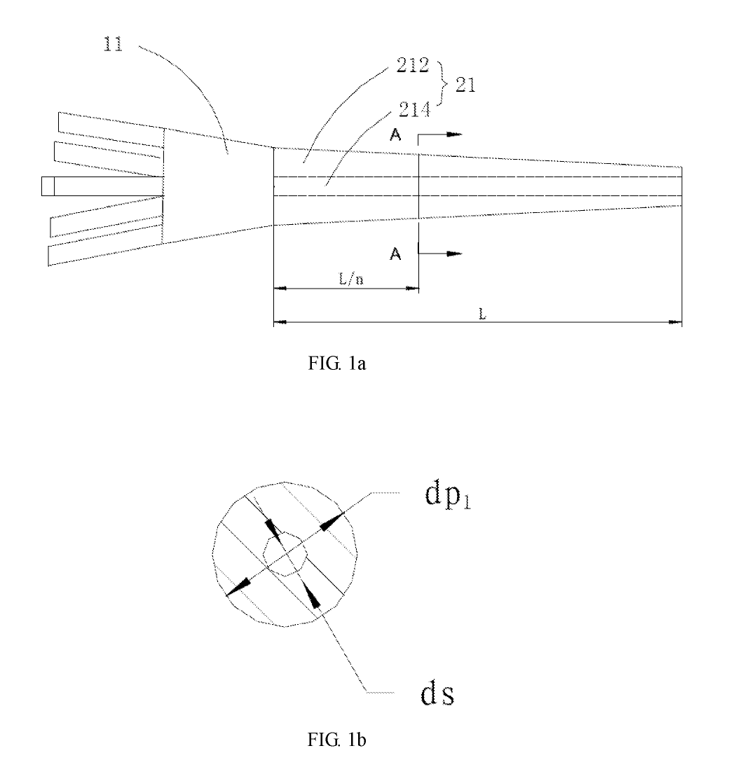

In the embodiment shown in FIG. 1a, the inner cladding 212 of the gain fiber 21 is tapered along an axial direction, and the diameter of the fiber core 214 of the gain fiber 21 remains invariable, causing the pump area to be less when the position of the pump light is transmitted far. Thus the pump light input is smaller and smaller, but the absorptive rate is higher and higher, thereby maintaining a homogeneous pump. FIG. 1b shows a cross section of a tail end of the first segment of the gain fiber 21, taken along line A-A, when the gain fiber 21 is divided into n segments. Specifically, the diameter ds of the fiber core remains invariable, the diameter of the inner cladding 212 gradually decreases from a position where the gain fiber 21 connecting the tapered fiber coupler 11, and satisfies the following formula

P*{1−10̂[−a(ds²/dp₁²)*L/n]}P*{10̂[−a(ds²/d₁²)*L/n]}*{1−10̂[−a(ds²/dp₂²)*L/n]}= . . . =P*{10̂[−a(ds²/dp₁² +. . . +ds²/dpₙ₋₁²)*L/ n]}*{1−10̂[−a(ds²/dpₙ²)*L/n]}

When the situation that the actual emergent angle of the pump light is no more than the numerical aperture of the inner cladding can be ensured, the taper angle of the gain fiber can be adjusted to enable a change of the absorption pump light of each segment to be relative less. The change of the actual absorption pump light of each segment of the gain fiber is little, the heating is mainly determined by a quantum defect between the excited laser and the pump light. Because the quantum defect is constant, thus the heating change is little. Therefore, a situation that the conventional fiber laser and the fiber laser amplifier have a poor homogeneity can be changed, the heat can be uniformly distributed along the whole gain fiber, a homogeneous heat dissipation of the fiber laser can be ensured, a heat damage resistant capability of the gain fiber can be greatly enhanced, thereby an actual power output of the fiber laser is greatly improved.

In one embodiment, a total length of the gain fiber 21 is 15.63 meters, the diameter of the fiber core 214 is 20 micrometers, absorption of the fiber core for the pump light is 100 decibels per meter. The diameter of the inner cladding of the pump light input end of the gain fiber 21 is 400 micrometers, the diameter of the inner cladding of the output end of the gain fiber 21 is 126.5 micrometers. At the time, the last remaining pump light (i.e. the pump light in the output end) is ten percent of the initial pump light (i.e. the pump light in the input end).

In other embodiment, the diameter dp of the inner cladding can also remain invariable, the diameter dsᵢ of the gain fiber core is changed, or the diameters of the inner cladding and the gain fiber core are changed together, but a value of (dpᵢ²)/(dpᵢ²) is ensured to be changed according to an equal proportion, i.e.

$$\frac{{ds}_{i + 1}^{2}}{{dp}_{i + 1}^{2}} / \frac{{ds}_{i}^{2}}{{dp}_{i}^{2}}$$

is a constant value.

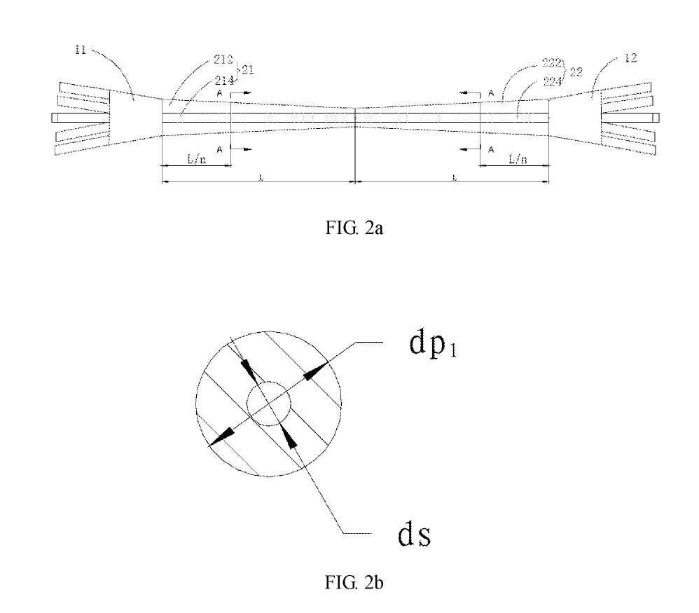

The embodiment of FIG. 1a, and FIG. 1b adopts a unidirectional pump structure having a single-end-pumped input, in other embodiment, the homogeneous pump structure is a bidirectional pump structure having a two-end-pumped input, as shown in FIG. 2a and FIG. 2b. Two gain fibers which are connected to each other (the gain fibers 21 and 22) are included, and the two gain fibers are mirror symmetric about a position where they are connected. Aforementioned embodiment can be referred for the calculation method of the size of the optical fiber, but a superposition of the inputs at the two ends should be considered. For the situation when they are not superposed, the embodiment of FIG. 2a is equivalent to a structure that formed by adding one mirror symmetry to the structure of FIG. 1a.

As described in the background, the tapered fiber coupling pump method is an improved end pump coupling method, such that above gain fiber can also be used in the common fiber laser and the laser amplifier. Specifically, the diameter dsᵢ of the fiber core can remain invariable, the diameter dpᵢ of the inner cladding gradually decreases from a position where the gain fiber connecting the dichroic mirror; or the diameter dp of the inner cladding of the gain fiber remains invariable, and the diameter of the fiber core gradually increases from the position where the gain fiber connecting the dichroic mirror; or the diameters of inner cladding and the gain fiber core change together, but a value of (dsᵢ²)/dpᵢ²) is ensured to be changed according to an equal proportion, i.e.

$$\frac{{ds}_{i + 1}^{2}}{{dp}_{i + 1}^{2}} / \frac{{ds}_{i}^{2}}{{dp}_{i}^{2}}$$

is a constant value

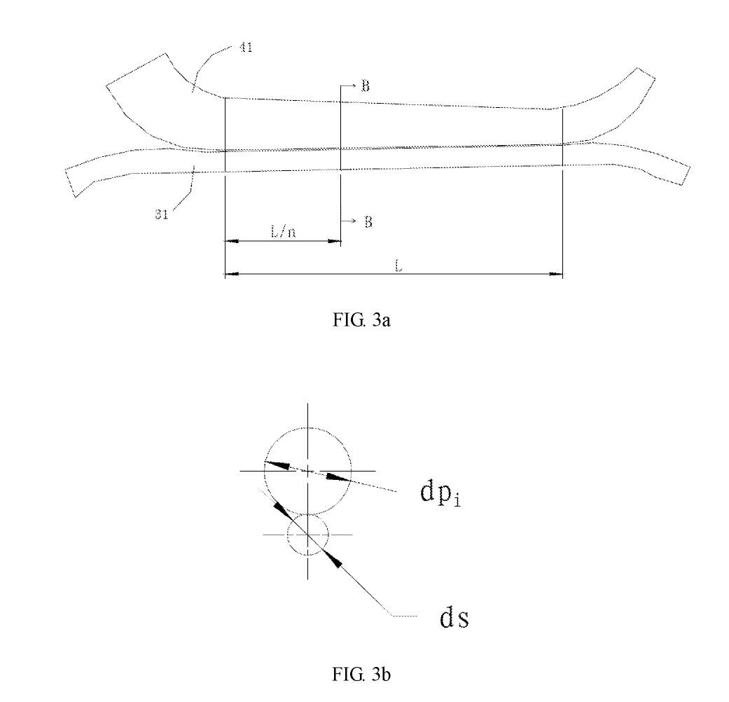

FIG. 3a is a perspective view of a gain fiber and a pump fiber of a fiber laser of a side pumping method in a unidirectional pump structure according to an embodiment. As shown in FIG. 3a and FIG. 3b, the cross sections of the gain fiber 31 and the pump fiber 41 are circulars, and contact each other. The pump light introduced into the pump fiber 41 can enter the gain fiber 31 through the contact surfaces of the two optical fibers. A segment of a middle portion of the gain fiber 31 which contacts the pump fiber 41 so as to be able to absorb the pump light is defined as a pump light absorption segment. The pump light initial power introduced into the pump fiber 41 is defined as P, the total length of the pump light absorption segment of the gain fiber 31 is defined as L, the pump light absorption segment is divided into n segments with equal lengths, the diameter of one segment of the pump light absorption segment is dsᵢ(i∈[1, n] and i is a natural number, the diameter dsᵢ of the pump light absorption segment indicates the diameter of the fiber core plus the diameter of the claddings), a diameter of the pump fiber is dpᵢ, the adsorption of the pump light by the gain fiber 31 is a decibels per meter. In order to satisfy a condition in which a pump area of the gain fiber gradually decreases from the pump light input end to the pump light output end, a ratio of the diameter dsᵢ of pump light absorption segment to the diameter dpᵢ of the pump fiber is gradually increased. It is illustrated with reference to one embodiment in the following:

For the first segment of the pump light absorption segment starting from the input side of the pump light, the power of absorbing the pump light is:

$$P * [ 1 - 10 \hat{} ( - a * \frac{{ds}_{1}^{2}}{{dp}_{1}^{2} + {ds}_{1}^{2}} * L / n ) ] ;$$

For the second segment of the pump light absorption segment, the power of absorbing the pump light is:

$$P * [ 10 \hat{} ( - a * \frac{{ds}_{1}^{2}}{{dp}_{1}^{2} + {ds}_{1}^{2}} * L / n ) ] * [ 1 - 10 \hat{} ( - a * \frac{{ds}_{2}^{2}}{{dp}_{2}^{2} + {ds}_{2}^{2}} * L / n ) ]$$

Similarly, for the nth segment of the pump light absorption segment, the power of absorbing the pump light is:

$$P * \{ 10 \hat{} [ - a * ( \frac{{ds}_{1}^{2}}{{dp}_{1}^{2} + {ds}_{1}^{2}} + … + \frac{{ds}_{n - 1}^{2}}{{dp}_{n - 1}^{2} + {ds}_{n - 1}^{2}} ) * L / n ] \} * \{ 1 - 10 \hat{} [ - a * \frac{{ds}_{n}^{2}}{{dp}_{n}^{2} + {ds}_{n}^{2}} * L / n ] \}$$

The L, a and n are given, various required combinations which enable the pump light absorption power of each segment of the pump light absorption segment to be equal can be solved by virtue of mathematical calculation software tools such as Matlab, and Maple. In practical production, the cross section of the manufactured pump fiber and the gain fiber may not be circular, and rather, it has shapes such as octagon, D shaped, and hexagon. One skilled in the art can make the manufactured pump fiber and gain fiber equivalent to circular cross sections according to a requirement, after that, on basis of above theoretical calculation, an adjustment within ±c % is performed to the actual diameter of the pump fiber and the actual diameter of the gain fiber, c is an empirical value. In the embodiment shown in FIG. 3a and FIG. 3b, the diameter ds of the pump light absorption segment of the gain fiber 31 remains invariable, the diameter dpᵢ of the pump fiber 41 gradually decreases from the pump light input side, and satisfies the following formula:

$$P * [ 1 - 10 \hat{} ( - a * \frac{{ds}^{2}}{{dp}_{1}^{2} + {ds}^{2}} * L / n ) ] = P * [ 10 \hat{} ( - a * \frac{{ds}^{2}}{{dp}_{1}^{2} + {ds}^{2}} * L / n ) ] * [ 1 - 10 \hat{} ( - a * \frac{{ds}^{2}}{{dp}_{2}^{2} + {ds}^{2}} * L / n ) ] = … = P * \{ 10 \hat{} [ - a * ( \frac{{ds}^{2}}{{dp}_{1}^{2} + {ds}^{2}} + … + \frac{{ds}^{2}}{{dp}_{n - 1}^{2} + {ds}^{2}} ) * L / n ] \} * \{ 1 - 10 \hat{} [ - a * \frac{{ds}^{2}}{{dp}_{n}^{2} + {ds}^{2}} * L / n ] \}$$

Because the pump light 41 is a passive optical fiber and is tapered, thus a production difficulty of aforementioned structure is relative less. It is apparently, in other embodiment, the diameter dp of the pump fiber can also remain invariable, the diameter dpᵢ of the pump light absorption segment of the gain fiber gradually increases from the pump light input side.

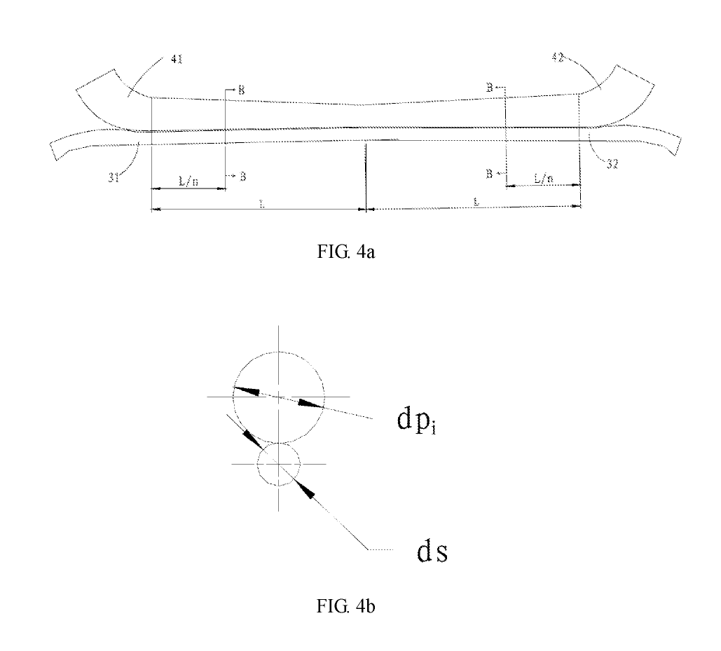

The embodiment shown in FIG. 3a and FIG. 3b adopts a unidirectional pump structure having a side-end-pumped input, in other embodiment, the homogeneous pump structure a bidirectional pump structure having a two-end-pumped input, as shown in FIG. 4a and FIG. 4B. Two gain fibers 31 and 32 which are connected to each other and two pump fibers 41 and 42 which are connected to each other are included. The two gain fibers 31 and 32 are mirror symmetric about a position where they are connected. The two pump fibers 41 and 42 are mirror symmetric about a position where they are connected.

The above are several embodiments of the present invention described in detail, and should not be deemed as limitations to the scope of the present invention. It should be noted that variations and improvements will become apparent to those skilled in the art to which the present invention pertains without departing from its spirit and scope. Therefore, the scope of the present invention is defined by the appended claims.

1. A homogeneous pump structure of a laser used in a fiber laser or a fiber laser amplifier, comprising:
a gain fiber having a pump light input end and a pump light output end, wherein a pump area of the gain fiber gradually decreases from the pump light input end to the pump light output end, such that a change rate of a pump light absorption capacity between each segment with an equal length and an adjacent segment of the gain fiber is less than b %, wherein b is an empirical value.

2. The homogeneous pump structure of the laser according to claim 1, wherein the homogeneous pump structure adopts a tapered fiber coupling pump method, the gain fiber comprises a fiber core and an inner cladding which is in contact with and closely surrounds the fiber core, when a cross section area of the gain fiber is equivalent to a circular, a ratio of a diameter of the fiber core to a diameter of the inner cladding gradually increases from the pump light input end to the pump light output end.

3. The homogeneous pump structure of the laser according to claim 1, wherein the homogeneous pump structure adopts an end pumped method, the gain fiber comprises a fiber core and an inner cladding which is contact with and closely surrounds the fiber core, when a cross section area of the gain fiber is equivalent to a circular, a ratio of a diameter of the fiber core to a diameter of the inner cladding increases gradually.

4. The homogeneous pump structure of the laser according to claim 1, wherein a deviation between a diameter of an actual fiber core and a diameter of a theoretical designed fiber core falls within ±c %, a deviation between a diameter of an actual inner cladding and a diameter of a theoretical designed inner cladding falls within ±c %, wherein c is an empirical value, the diameter of the theoretical designed fiber core and the diameter of the theoretical designed inner cladding satisfy the following conditions:
P*{1−10̂[−a(ds₁²/dp₁²)*L/n]}P*{10̂[−a(ds₁²/dp₁²)*L/n]}*{1−10̂[−a(ds₂²/dp₂²)*L/n]}= . . . =P*{10̂[−a(ds₁²/dp₁²+ . . . +dsₙ₋₁²/dpₙ₋₁²)*L/n]}*{1−10̂[−a(dsₙ²/dpₙ²)*L/n]}
wherein P represents an initial power of the pump light inputted into the gain fiber, L represents a total length of the gain fiber, n represents that the gain fiber is divided into n segments with equal lengths, dsᵢ represents the theoretical designed diameter of each segment of the fiber core, dpᵢ represents the theoretical designed diameter of each segment the inner cladding, a represents that an adsorption of the pump light by the fiber core is a decibels per meter.

5. The homogeneous pump structure of the laser according to claim 4, wherein the theoretical designed diameter ds of the fiber core remains invariable, the theoretical designed diameter of the inner cladding gradually decreases from the pump light input end.

6. The homogeneous pump structure of the laser according to claim 4, wherein the theoretical designed diameter dp of the inner cladding remains invariable, the theoretical designed diameter of the fiber core gradually increases from the pump light input end.

7-9. (canceled)

10. The homogeneous pump structure of the laser according to claim 1, wherein the homogeneous pump structure adopts a side pump method, and the homogeneous pump structure comprises a pump fiber and a gain fiber contacting each other, when a cross section area of the gain fiber is equivalent to a circular, a ratio of a diameter of an the pump light absorption segment of the gain fiber to a diameter of the pump fiber gradually increases from the pump light input end to the pump light output end.

11. The homogeneous pump structure of the laser according to claim 10, wherein a deviation between a diameter of an actual pump fiber and a diameter of a theoretical designed pump fiber falls within ±c %, a deviation between a diameter of an actual gain fiber and a diameter of a theoretical designed gain fiber falls within ±c %, c is an empirical value, the diameter of the theoretical designed pump fiber and the diameter of the theoretical designed gain fiber satisfy the following conditions:
$$P * [ 1 - 10 \hat{} ( - a * \frac{{ds}_{1}^{2}}{{dp}_{1}^{2} + {ds}_{1}^{2}} * L / n ) ] = P * [ 10 \hat{} ( - a * \frac{{ds}_{1}^{2}}{{dp}_{1}^{2} + {ds}_{1}^{2}} * L / n ) ] * [ 1 - 10 \hat{} ( - a * \frac{{ds}_{2}^{2}}{{dp}_{2}^{2} + {ds}_{2}^{2}} * L / n ) ] = … = P * \{ 10 \hat{} [ - a * ( \frac{{ds}_{1}^{2}}{{dp}_{1}^{2} + {ds}_{1}^{2}} + … + \frac{{ds}_{n - 1}^{2}}{{dp}_{n - 1}^{2} + {ds}_{n - 1}^{2}} ) * L / n ] \} * \{ 1 - 10 \hat{} [ - a * \frac{{ds}_{n}^{2}}{{dp}_{n}^{2} + {ds}_{n}^{2}} * L / n ] \}$$
wherein P represents an initial power of the pump light inputted into the pump fiber, L represents a total length of the pump light absorption segment of the gain fiber, n represents that the pump light absorption segment is divided into n segments with equal lengths, dsᵢ represents the theoretical designed diameter of one segment of the pump light absorption segment, dpᵢ represents the theoretical designed diameter of one segment the pump fiber, a represents that an adsorption of the pump light by the gain fiber is a decibels per meter

12. The homogeneous pump structure of the laser according to claim 11, wherein the theoretical designed diameter ds of the pump light absorption segment of the gain fiber remains invariable, the theoretical designed diameter of the pump fiber gradually decreases from the pump light input side.

13. The homogeneous pump structure of the laser according to claim 11, wherein the theoretical designed diameter dp of the pump fiber remains invariable, the theoretical designed diameter of the pump light absorption segment of the gain fiber gradually increases from the pump light input side.

14. The homogeneous pump structure of the laser according to claim 11, wherein the homogeneous pump structure is a unidirectional pump structure having a single-end-pumped input.

15. The homogeneous pump structure of the laser according to claim 11, wherein the homogeneous pump structure is a bidirectional pump structure having a double-end-pumped input, a number of the gain fibers is two, a number of the pump fibers is two, the two gain fibers are connected to each other and mirror symmetric about a position where they are connected, the two pump fibers are connected to each other and mirror symmetric about a position where they are connected.

16. A method of designing a homogeneous pump structure of a laser used in a fiber laser and a fiber laser amplifier, the structure comprising a gain fiber having a pump light input end and a pump light output end, the method comprising:
making a cross section area of the gain fiber equivalent to a circular;
giving a total length L to the gain fiber, giving a decibels per meter to an adsorption of the pump light by the fiber core of the gain fiber, dividing the gain fiber into n segments with equal lengths;
designing an appropriate diameter of a theoretical designed fiber core and an appropriate diameter of a theoretical designed inner cladding to satisfy the following formula:
P*{1−10̂[−a(ds₁²/dp₁²)*L/n]}P*{10̂[−a(ds₁²/dp₁²)*L/n]}*{1−10̂[−a(ds₂²/dp₂²)*L/n]}= . . . +P*{10̂[−a(ds₁²/dp₁² + . . . +dsₙ₋₁²/dpₙ₋₁²)*L/n]}*{1−10̂[−a(dsₙ²/dpₙ²)*L/n]}
wherein P represents an initial power of the pump light inputted into the gain fiber, dsᵢ represents the theoretical designed diameter of one segment of the fiber core, dpᵢ represents the theoretical designed diameter of one segment of the inner cladding.

17. The method for designing a homogeneous pump structure of a laser according to claim 16, wherein the homogeneous pump structure adopts a tapered fiber coupling pump method.

18. The method for designing a homogeneous pump structure of a laser according to claim 16, wherein the homogeneous pump structure of a laser adopts an end pumped method.

19. The method for designing a homogeneous pump structure of a laser according to claim 16, wherein the theoretical designed diameter ds of the fiber core of the gain fiber remains invariable, the theoretical designed diameter of the inner cladding gradually decreases from the pump light input end.

20. The method for designing a homogeneous pump structure of a laser according to claim 16, wherein the theoretical designed diameter dp of the inner cladding of the gain fiber remains invariable, the theoretical designed diameter of the fiber core gradually increases from the pump light input end.

21-23. (canceled)

24. The method for designing a homogeneous pump structure of a laser according to claim 16, further comprising: manufacturing a gain fiber according to a diameter of a theoretical designed fiber core and a diameter of a theoretical designed inner cladding which are obtained by calculation, wherein a deviation between a diameter of an actual fiber core of the manufactured gain fiber and a diameter of a theoretical designed fiber core falls within ±c %, a deviation between a diameter of an actual inner cladding of the manufactured gain fiber and a diameter of a theoretical designed inner cladding falls within ±c %.

25. A method for designing a homogeneous pump structure of a laser used in a fiber laser and a fiber laser amplifier, the structure adopting a side pumped method and comprising a pump fiber and a gain fiber, the method comprising:
making cross sections of the pump fiber and the gain fiber equivalent to circulars;
giving a total length L to the pump light absorption segment of the gain fiber, giving a decibels per meter to an adsorption of the pump light by the gain fiber, dividing the pump light absorption segment into n segments with equal lengths;
designing an appropriate diameter of a theoretical designed pump fiber and an appropriate diameter of a theoretical designed gain fiber to satisfy the following formula:
$$P * [ 1 - 10 \hat{} ( - a * \frac{{ds}_{1}^{2}}{{dp}_{1}^{2} + {ds}_{1}^{2}} * L / n ) ] = P * [ 10 \hat{} ( - a * \frac{{ds}_{1}^{2}}{{dp}_{1}^{2} + {ds}_{1}^{2}} * L / n ) ] * [ 1 - 10 \hat{} ( - a * \frac{{ds}_{2}^{2}}{{dp}_{2}^{2} + {ds}_{2}^{2}} * L / n ) ] = … = P * \{ 10 \hat{} [ - a * ( \frac{{ds}_{1}^{2}}{{dp}_{1}^{2} + {ds}_{1}^{2}} + … + \frac{{ds}_{n - 1}^{2}}{{dp}_{n - 1}^{2} + {ds}_{n - 1}^{2}} ) * L / n ] \} * \{ 1 - 10 \hat{} [ - a * \frac{{ds}_{n}^{2}}{{dp}_{n}^{2} + {ds}_{n}^{2}} * L / n ] \}$$
wherein P represents an initial power of the pump light inputted into the pump fiber, dsᵢ represents the theoretical designed diameter of one segment of the pump light absorption segment, dpᵢ represents the theoretical designed diameter of one segment of the pump fiber.

26. The method for designing a homogeneous pump structure of a laser according to claim 25, wherein the theoretical designed diameter ds of the pump light absorption segment of the gain fiber remains invariable, the theoretical designed diameter of the pump fiber gradually decreases from the pump light input side.

27-30. (canceled)
